(19) United States
(12) Patent Application Publication
(10) Pub. No.: US 2015/0362683 A1
(43) Pub. Date: Dec. 17, 2015

(54) Method And Optical Coupling Package With A Locking Device For A Fiber Array Subassembly And A Lens Array

(71) Applicant: SiFotonics Technologies Co., Ltd., Woburn, MA (US)

(72) Inventors: Shipeng Yan, Beijing (CN); Jack Yuan, Saratoga, CA (US); Dong Pan, Andover, MA (US)

(73) Assignee: SIFOTONICS TECHNOLOGIES CO., LTD., Woburn, MA (US)

(21) Appl. No.: 14/498,455

(22) Filed: Sep. 26, 2014

Related U.S. Application Data
(60) Provisional application No. 61/998,019, filed on Jun. 16, 2014.

(51) Int. Cl. G02B 6/42

(52) U.S. Cl. CPC G02B 6/4206; G02B 6/4219

(57) ABSTRACT

Various embodiments of a novel method and design for coupling optical signals from a lens array to a fiber array subassembly with locking capability in a pluggable form factor are provided. Optical signals vertically emitted from a vertical-cavity surface-emitting laser (VCSEL) array on a printed circuit board (PCB) are coupled into an optical coupling lens array, which are then coupled into a fiber array subassembly parallel to the PCB. A locking device in a pluggable form factor provides means for mating and locking between the lens array and the fiber array subassembly, thereby achieving good coupling and locking between the fiber array subassembly and lens array.

### CROSS-REFERENCE TO RELATED PATENT APPLICATION(S)

This is a non-provisional application that claims the priority benefit of U.S. Patent Application No. 61/998,019, filed on Jun. 16, 2014, which is incorporated by reference in its entirety.

### TECHNICAL FIELD

The present disclosure relates to optical coupling and, more particularly, to a method and optical coupling package with a locking device for a fiber array subassembly and an optical coupling lens array.

### BACKGROUND

A fiber optic coupler is a device used in optoelectronic systems with one or more input fibers and one or several output fibers. Light entering an input fiber can appear at one or more outputs and its power distribution potentially depending on the wavelength and polarization. A fiber optic coupler may couple a lens array and a fiber array. However, good coupling between the lens array and fiber array is often difficult to achieve.

### SUMMARY

Various embodiments of a novel method and design for coupling optical signals from a lens array to a fiber array subassembly with locking capability in a pluggable form factor are provided. Optical signals vertically emitted from a vertical-cavity surface-emitting laser (VCSEL) array on a printed circuit board (PCB) are coupled into an optical coupling lens array, which are then coupled into a fiber array subassembly parallel to the PCB. A locking device in a pluggable form factor provides means for mating and locking between the lens array and the fiber array subassembly, thereby achieving good coupling and locking between the fiber array subassembly and lens array.

In one aspect, an optical coupling package may include a lens array module and a fiber array subassembly. The lens array module and the fiber array subassembly may include features forming a locking device configured such that the fiber array subassembly is interlockingly pluggable into and unplugged from the lens array module.

### BRIEF DESCRIPTION OF THE DRAWINGS

The accompanying drawings are included to provide a further understanding of the present disclosure, and are incorporated in and constitute a part of this specification. The drawings illustrate embodiments of the present disclosure and, together with the description, serve to explain the principles of the present disclosure. The drawings may not necessarily be in scale so as to better present certain features of the illustrated subject matter.

FIG. 1 shows a perspective view of an optical coupling package of an embodiment of the present disclosure.

FIG. 2 shows a top view of a lens array module of the optical coupling package of an embodiment of the present disclosure.

FIG. 3 shows a top view of a fiber array subassembly of the optical coupling package of an embodiment of the present disclosure.

FIG. 4 shows an assembly view of the fiber array subassembly of the optical coupling package of an embodiment of the present disclosure.

FIG. 5 shows a top view of the optical coupling package of an embodiment of the present disclosure.

FIG. 6 shows a side view of the optical coupling package of an embodiment of the present disclosure.

FIG. 7 shows a perspective view of two optically coupling lens array modules coupled to a PCB of the optical coupling package of an embodiment of the present disclosure.

### DETAILED DESCRIPTION OF THE PREFERRED EMBODIMENTS

### Example Implementations

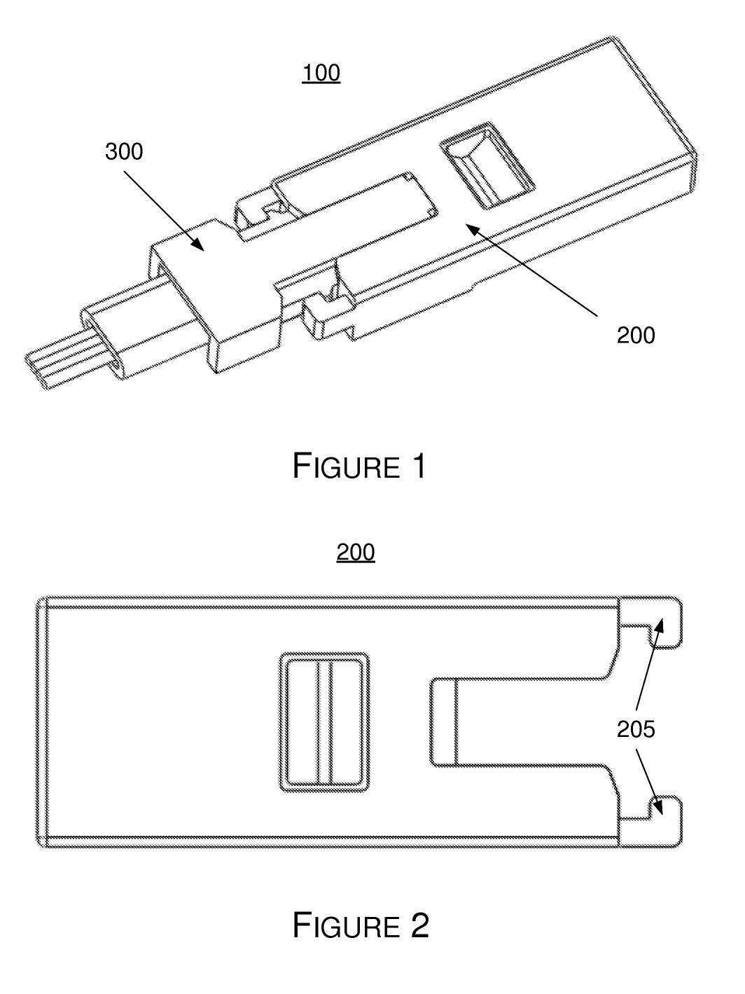

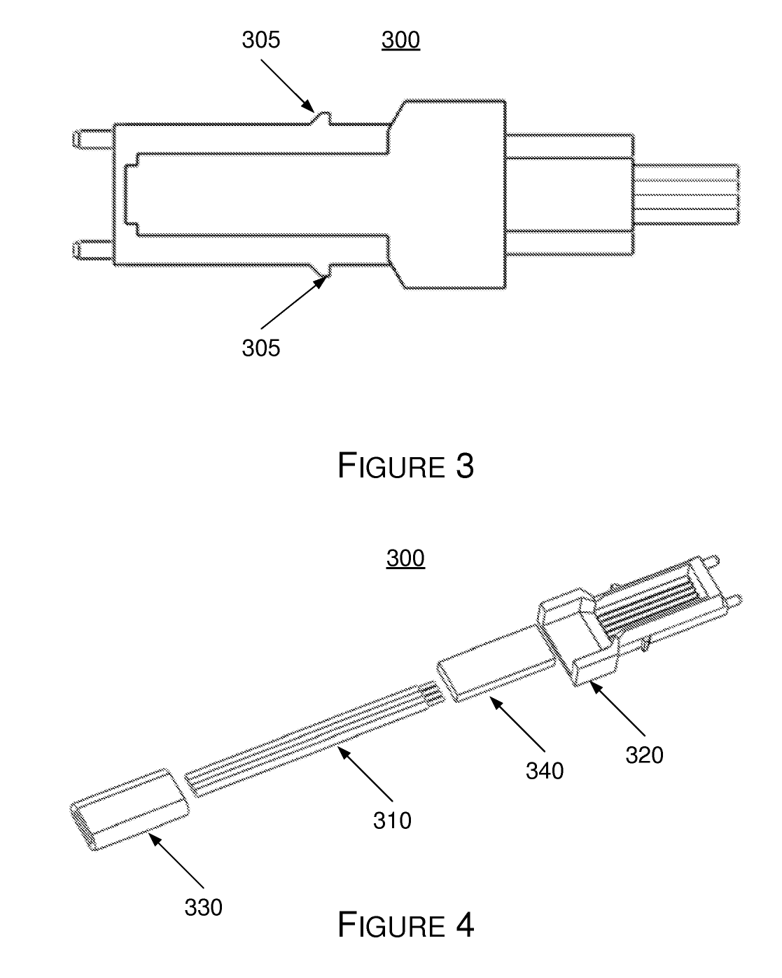

FIGS. 1-7 illustrate various views and components of an optical coupling package 100 of an embodiment of the present disclosure. Referring to FIGS. 1-6, optical coupling package 100 includes a lens array module 200 and a fiber array subassembly 300. As shown in FIG. 2, optically coupling lens array module 200 includes a hooking mechanism 205, e.g., two hooks. As shown in FIG. 3, fiber array subassembly 300 is designed with corresponding tabs 305 to engage with, latch onto, interlock with or otherwise interact with hooking mechanism 205 of lens array module 200. That is, hooking mechanism 205 of optically coupling lens array module 200 and tabs 305 fiber array subassembly 300 form a locking device of optical coupling package 100. This locking device allows fiber array subassembly 300 to be interlockingly plugged into and unplugged from optically coupling lens array module 200.

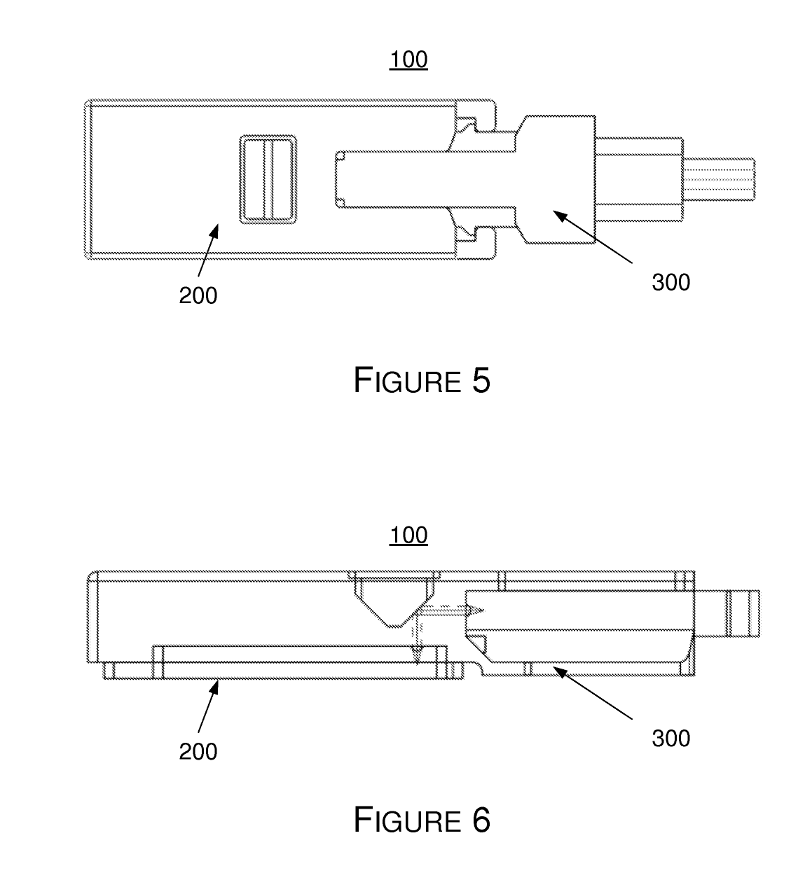

In some embodiments, the hooking mechanism 205 of lens array module 200 may be made from a molded resin material such that the hooks of hooking mechanism 205 may have a degree of flexibility to ensure smooth plugging and unplugging of fiber array subassembly 300. As shown in FIGS. 5 and 6, fiber array subassembly 300 is interlockingly plugged into lens array module 200, and both are “locked” by the locking device of the hooking mechanism 205 and tabs 305. Advantageously, the locking device itself occupies minimal space, has low manufacturing cost, and is easy to fabricate in mass production.

In some embodiments, lens array module 200 may include one or more, e.g., two, positioning guide holes and, correspondingly, fiber array subassembly 300 may include one or more, e.g., two, positioning protrusions configured to be respectively received in the positioning guide holes of optically coupling lens array module 200. Alternatively, fiber array subassembly 300 may include one or more, e.g., two, positioning guide holes and, correspondingly, optically coupling lens array module 200 may include one or more, e.g., two, positioning protrusions configured to be respectively received in the positioning guide holes of fiber array subassembly 300. The feature of positioning guide hole(s) and corresponding positioning protrusion(s) ensures that the fiber array subassembly 300 can be precisely mated to the optically coupling lens array module 200.

As shown in FIG. 4, in some embodiments, fiber array subassembly 300 may include four parts, namely: a fiber array 310 having a plurality of optical fibers, a V-groove 320 with a guide pin, a protective tube 330 configured to shroud around the fiber array 310, and adhesive disposed, and functioning as an interface, between the V-groove 320 and the fiber array 310.

Lens array module 200 may include a 90-degree reflective surface such that an incoming light beam from the optical fibers of the fiber array 310 of fiber array subassembly 300 can meet the reflective surface vertically, as shown in FIG. 6. In some embodiments, lens array module 200 may include two sets of lenses, namely a first set of lenses and a second set of lenses. The first set of lenses may focus the incoming light beam, or signal(s), after the incoming light beam is reflected by the 90-degree reflective surface. The second set of lenses may refocus an outgoing light beam, as shown in FIG. 6. In some embodiments, lenses of the first and second sets of lenses may be aligned such that a center of each of the lenses is on a same line. In some embodiments, a quantity of the lenses of the first and second sets of lenses may range from 2 to 12.

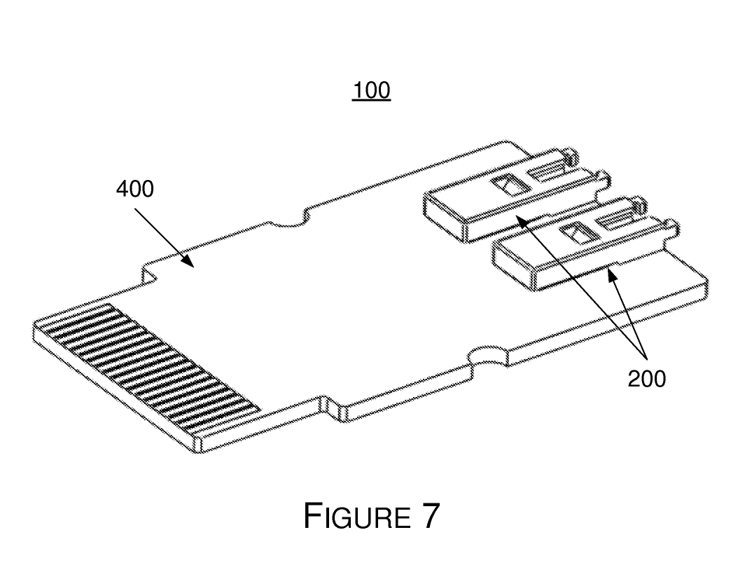

As shown in FIG. 7, in some embodiments, one or more units of lens array module 200 may first be attached to, mounted on or otherwise coupled to a PCB 400. Subsequently, fiber array subassembly 300 may be interlockingly plugged into lens array module 200 and locked by the locking device described above.

### Highlights of Select Features

In view of the above, features of the present disclosure are highlighted below.

In one aspect, an optical coupling package may include a lens array module and a fiber array subassembly. The lens array module and the fiber array subassembly may include features forming a locking device configured such that the fiber array subassembly is interlockingly pluggable into and unplugged from the lens array module.

In some embodiments, the lens array module may include a hooking mechanism as a part of the locking device.

In some embodiments,the hooking mechanism may be made from a molded resin material such that the hooking mechanism has a degree of flexibility to ensure smooth plugging and unplugging of the fiber array subassembly.

In some embodiments, the fiber array subassembly may include tabs as another part of the locking device and configured to engage with the hooking mechanism of the lens array module.

In some embodiments, the lens array module may include one or more positioning guide holes and the fiber array subassembly may include one or more positioning protrusions configured to be correspondingly received in the one or more positioning guide holes such that the fiber array subassembly is precisely mated to the lens array module.

In some embodiments, the fiber array subassembly may include one or more positioning guide holes and lens array module may include one or more positioning protrusions configured to be correspondingly received in the one or more positioning guide holes such that the fiber array subassembly is precisely mated to the lens array module.

In some embodiments, the fiber array subassembly may include a fiber array comprising a plurality of optical fibers, a V-groove with a guide pin, a protective tube configured to shroud around the fiber array, and an adhesive disposed and functioning as an interface between the V-groove and the fiber array.

In some embodiments, the lens array module may include a 90-degree reflective surface such that an incoming light beam from the fiber array subassembly meets the 90-degree reflective surface vertically.

In some embodiments, the lens array module may include a first set of lenses and a second set of lenses. The first set of lenses may focus the incoming light beam after the 90-degree reflective surface. The second set of lenses may refocus an outgoing light beam.

In some embodiments, the lenses of the first and second sets of lenses may be aligned such that a center of each of the lenses is on a same line.

In some embodiments, a quantity of the lenses of the first and second sets of lenses may range from 2 to 12.

In some embodiments, the optical coupling package may further include a PCB to which the lens array module is coupled.

### Additional Notes

Although some embodiments are disclosed above, they are not intended to limit the scope of the present disclosure. It will be apparent to those skilled in the art that various modifications and variations can be made to the disclosed embodiments of the present disclosure without departing from the scope or spirit of the present disclosure. In view of the foregoing, the scope of the present disclosure shall be defined by the following claims and their equivalents.

1. An optical coupling package, comprising:
a lens array module; and
a fiber array subassembly,
wherein the lens array module and the fiber array subassembly comprise features forming a locking device configured such that the fiber array subassembly is interlockingly pluggable into and unplugged from the lens array module.

2. The optical coupling package of claim 1, wherein the lens array module comprises a hooking mechanism as a part of the locking device.

3. The optical coupling package of claim 2, wherein the hooking mechanism is made from a molded resin material such that the hooking mechanism has a degree of flexibility to ensure smooth plugging and unplugging of the fiber array subassembly.

4. The optical coupling package of claim 2, wherein the fiber array subassembly comprises tabs as another part of the locking device and configured to engage with the hooking mechanism of the lens array module.

5. The optical coupling package of claim 1, wherein the lens array module comprises one or more positioning guide holes and the fiber array subassembly comprises one or more positioning protrusions configured to be correspondingly received in the one or more positioning guide holes such that the fiber array subassembly is precisely mated to the lens array module.

6. The optical coupling package of claim 1, wherein the fiber array subassembly comprises one or more positioning guide holes and lens array module comprises one or more positioning protrusions configured to be correspondingly received in the one or more positioning guide holes such that the fiber array subassembly is precisely mated to the lens array module.

7. The optical coupling package of claim 1, wherein the fiber array subassembly comprises:
a fiber array comprising a plurality of optical fibers;
a V-groove with a guide pin;
a protective tube configured to shroud around the fiber array; and
an adhesive disposed and functioning as an interface between the V-groove and the fiber array.

8. The optical coupling package of claim 1, wherein the lens array module comprises a 90-degree reflective surface such that an incoming light beam from the fiber array subassembly meets the 90-degree reflective surface vertically.

9. The optical coupling package of claim 8, wherein the lens array module comprises:
a first set of lenses; and
a second set of lenses,
wherein the first set of lenses focuses the incoming light beam after the 90-degree reflective surface, and
wherein the second set of lenses refocuses an outgoing light beam.

10. The optical coupling package of claim 9, wherein the lenses of the first and second sets of lenses are aligned such that a center of each of the lenses is on a same line.

11. The optical coupling package of claim 9, wherein a quantity of the lenses of the first and second sets of lenses ranges from 2 to 12.

12. The optical coupling package of claim 1, further comprising:
a printed circuit board (PCB) to which the lens array module is coupled.
